(19) United States
(12) Patent Application Publication
(10) Pub. No.: US 2020/0019857 A1
(43) Pub. Date: Jan. 16, 2020

(54) Watermark Embedding Techniques for Neural Networks and Their Use

(71) Applicant: Nokia Technologies Oy, Espoo (FI)

(72) Inventors: Tinghuai Wang, Tampere (FI); Lixin Fan, Tampere (FI)

(73) Assignee: Nokia Technologies Oy

(21) Appl. No.: 16/508,434

(22) Filed: Jul. 11, 2019

Related U.S. Application Data
(60) Provisional application No. 62/697,114, filed on Jul. 12, 2018.

(51) Int. Cl. G06N 3/08; G06N 20/10; G06K 9/62; G06F 17/18

(52) U.S. Cl. CPC G06N 3/08; G06F 17/18; G06K 9/6223; G06N 20/10

(57) ABSTRACT

A NN is trained using a cost function that places constraints on weights in the NN. The constraints are based on key(s) and cluster center(s) of the weights. The training embeds a capability to produce signature(s) corresponding to the key(s). Information is output that corresponds to the trained NN for testing a NN to determine if the tested NN is or is not verifiable as the trained NN. A NN is tested using the key(s) to determine output signature(s). The output signature(s) are compared, using a metric, with other signature(s) that correspond to the key(s). Based on the comparison, it is determined whether the NN is or is not verified as a known NN with the embedded capability to produce specific signatures corresponding to the key(s). In response to the NN being determined to be verified as the known NN, the NN is reported as being verified.

### CROSS-REFERENCE TO RELATED APPLICATIONS

The present application claims the benefit under 35 U.S.C. § 119(e) or other applicable laws of U.S. Provisional Patent Application No. 62/697,114, filed on Jul. 12, 2018, the disclosure of which is hereby incorporated by reference in its entirety.

### TECHNICAL FIELD

This invention relates generally to neural networks and, more specifically, relates to watermarking using neural networks.

### BACKGROUND

This section is intended to provide a background or context to the invention disclosed below. The description herein may include concepts that could be pursued, but are not necessarily ones that have been previously conceived, implemented or described. Therefore, unless otherwise explicitly indicated herein, what is described in this section is not prior art to the description in this application and is not admitted to be prior art by inclusion in this section. Abbreviations that may be found in the specification and/or the drawing figures are defined below, at the beginning of the detailed description section.

Neural networks (NNs) have recently prompted an explosion of intelligent applications for Internet of things (IoT) devices, such as mobile phones, smart watches and smart home appliances. Albeit transferring data to a centralized computation server for processing is appealing considering the high computational complexity and battery consumption, concerns over data privacy and latency of large volume data transmission have been promoting distributed computation scenarios. To this end, many companies and research institutions are working toward standardizing common communication and representation formats for neural networks in order to enable the efficient, error resilient and safe transmission and reception among device or service vendors.

Although this standardization is an improvement, there are still detriments to be overcome in sharing neural networks, particularly from an intellectual property perspective, as vendors might be reluctant to share their neural networks if their neural networks can be easily stolen and used without their permission.

### BRIEF SUMMARY

This section is intended to include examples and is not intended to be limiting.

In an exemplary embodiment, a method is disclosed that includes training a neural network using a cost function that places constraints on weights in the neural network. The constraints are based on one or more keys and one or more cluster centers of the weights. The training embeds a capability to produce one or more signatures corresponding to the one or more keys. The method includes outputting information corresponding to the trained neural network for testing a neural network to determine if the tested neural network is or is not verifiable as the trained neural network.

An additional exemplary embodiment includes a computer program, comprising code for performing the method of the previous paragraph, when the computer program is run on a processor. The computer program according to this paragraph, wherein the computer program is a computer program product comprising a computer-readable medium bearing computer program code embodied therein for use with a computer. Another example is the computer program according to this paragraph, wherein the program is directly loadable into an internal memory of the computer.

An exemplary apparatus includes one or more processors and one or more memories including computer program code. The one or more memories and the computer program code are configured to, with the one or more processors, cause the apparatus to perform operations comprising: training a neural network using a cost function that places constraints on weights in the neural network, the constraints based on one or more keys and one or more cluster centers of the weights, wherein the training embeds a capability to produce one or more signatures corresponding to the one or more keys; and outputting information corresponding to the trained neural network for testing a neural network to determine if the tested neural network is or is not verifiable as the trained neural network.

An exemplary computer program product includes a computer-readable storage medium bearing computer program code embodied therein for use with a computer. The computer program code includes: code for training a neural network using a cost function that places constraints on weights in the neural network, the constraints based on one or more keys and one or more cluster centers of the weights, wherein the training embeds a capability to produce one or more signatures corresponding to the one or more keys; and code for outputting information corresponding to the trained neural network for testing a neural network to determine if the tested neural network is or is not verifiable as the trained neural network.

In another exemplary embodiment, an apparatus comprises: means for training a neural network using a cost function that places constraints on weights in the neural network, the constraints based on one or more keys and one or more cluster centers of the weights, wherein the training embeds a capability to produce one or more signatures corresponding to the one or more keys; and means for outputting information corresponding to the trained neural network for testing a neural network to determine if the tested neural network is or is not verifiable as the trained neural network.

In an exemplary embodiment, a method is disclosed that includes testing a neural network with one or more keys to determine one or more output signatures. The neural network has an embedded capability to produce one or more signatures corresponding to the one or more keys, and the capability is based on constraints placed on weights in the neural network during training. The constraints are based on one or more keys and one or more cluster centers of the weights, and the one or more cluster centers are based on weights used in the neural network. The method includes comparing, using a metric, the one or more output signatures with one or more other signatures that correspond to the one or more keys. The method also includes determining based on the comparison whether the neural network is or is not verified as a known neural network with the embedded capability to produce specific signatures corresponding to the one or more keys. The method also includes in response to the neural network determined to be verified as the known neural network, reporting the neural network as being verified.

An additional exemplary embodiment includes a computer program, comprising code for performing the method of the previous paragraph, when the computer program is run on a processor. The computer program according to this paragraph, wherein the computer program is a computer program product comprising a computer-readable medium bearing computer program code embodied therein for use with a computer. Another example is the computer program according to this paragraph, wherein the program is directly loadable into an internal memory of the computer.

An exemplary apparatus includes one or more processors and one or more memories including computer program code. The one or more memories and the computer program code are configured to, with the one or more processors, cause the apparatus to perform operations comprising: testing a neural network with one or more keys to determine one or more output signatures, wherein the neural network has an embedded capability to produce one or more signatures corresponding to the one or more keys, and the capability is based on constraints placed on weights in the neural network during training, the constraints based on one or more keys and one or more cluster centers of the weights, the one or more cluster centers based on weights used in the neural network; comparing, using a metric, the one or more output signatures with one or more other signatures that correspond to the one or more keys; determining based on the comparison whether the neural network is or is not verified as a known neural network with the embedded capability to produce specific signatures corresponding to the one or more keys; and in response to the neural network determined to be verified as the known neural network, reporting the neural network as being verified.

An exemplary computer program product includes a computer-readable storage medium bearing computer program code embodied therein for use with a computer. The computer program code includes: code for testing a neural network with one or more keys to determine one or more output signatures, wherein the neural network has an embedded capability to produce one or more signatures corresponding to the one or more keys, and the capability is based on constraints placed on weights in the neural network during training, the constraints based on one or more keys and one or more cluster centers of the weights, the one or more cluster centers based on weights used in the neural network; code for comparing, using a metric, the one or more output signatures with one or more other signatures that correspond to the one or more keys; code for determining based on the comparison whether the neural network is or is not verified as a known neural network with the embedded capability to produce specific signatures corresponding to the one or more keys; and code for in response to the neural network determined to be verified as the known neural network, reporting the neural network as being verified.

In another exemplary embodiment, an apparatus comprises: means for testing a neural network with one or more keys to determine one or more output signatures, wherein the neural network has an embedded capability to produce one or more signatures corresponding to the one or more keys, and the capability is based on constraints placed on weights in the neural network during training, the constraints based on one or more keys and one or more cluster centers of the weights, the one or more cluster centers based on weights used in the neural network; means for comparing, using a metric, the one or more output signatures with one or more other signatures that correspond to the one or more keys; means for determining based on the comparison whether the neural network is or is not verified as a known neural network with the embedded capability to produce specific signatures corresponding to the one or more keys; and means, responsive to the neural network determined to be verified as the known neural network, for reporting the neural network as being verified.

### BRIEF DESCRIPTION OF THE DRAWINGS

In the attached Drawing Figures:

FIG. 1 is a block diagram illustrating a training stage to embed keys and signatures into NN weights, in accordance with an exemplary embodiment;

FIG. 1A is a block diagram of computer system used for training a NN, in accordance with an exemplary embodiment;

FIG. 2 is a logic flow diagram for a training phase using watermark embedding techniques for neural networks, in accordance with exemplary embodiments;

FIG. 3 illustrates a testing case to detect designated signatures for given keys as inputs, in accordance with an exemplary embodiment;

FIG. 3A is a block diagram of computer system used for testing a NN for the testing case in FIG. 3, in accordance with an exemplary embodiment;

FIG. 4 illustrates a testing case to detect designated signatures for given testing data with keys embedded as inputs, in accordance with an exemplary embodiment;

FIG. 4A is a block diagram of computer system used for testing a NN for the testing case in FIG. 4, in accordance with an exemplary embodiment;

FIG. 5 is a logic flow diagram for a testing phase using watermark embedding techniques for neural networks, in accordance with exemplary embodiments;

FIG. 6, spread over FIGS. 6A and 6B, is an illustration of ResNet architecture;

FIG. 7 illustrates an example of dividing a 128×3×3 tensor into 18 64×1×1 tensors;

FIG. 8 illustrates clustering that is performed on extracted 64D tensors; and

FIG. 9 illustrates clustering that is performed on all 128×1×1 tensors.

### DETAILED DESCRIPTION OF THE DRAWINGS

The following abbreviations that may be found in the specification and/or the drawing figures are defined as follows:

3D three dimension(al)

AI artificial intelligence

D dimension

DNN deep neural networks (e.g., NNs with more than one hidden layer)

ID identification

I/F interface

IoT Internet of things

IP intellectual property

MPEG motion picture experts group

NN neural network

NNR neural network representation

N/W network

param parameter

ResNet residual network

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

For ease of reference, this disclosure is divided into sections.

### I. Introduction

Sharing trained models or parts of deep neural networks (DNNs) has been a very important practice in the rapid progress of research and development of AI systems. At the same time, it is imperative to protect the integrity of shared NN models. The integrity of the NN may include, as an example, intellectual property (IP) rights of the owner of the NN model.

Despite the urgent need of a mechanism to protect shared NN models, by and large, research work to address the issue is rare and almost neglected. This document discloses multiple NN protection mechanisms which timely answer this need.

There have been multiple proposals regarding NNR in MPEG meetings 121 and 122, which are related to error resilience of compressed representations. Additionally, a publication illustrated how to embed a set of binary codes into neural network weights, during the training of NNs. See Yusuke Uchida, Yuki Nagai, Shigeyuki Sakazawa, “Embedding Watermarks into Deep Neural Networks”, Shin'ichi Satoh, 2017 (arXiv:1701.04082v2 [cs.CV] 20 Apr. 2017). The assumption made there is that the over-parameterized NN weights have the capacity to encode an additional set of secret codes during the learning stage to accomplish its main task of, e.g., image classification. However, the subset or transformation of NN weights that was used there to encode secret codes is selected by a naïve scheme, i.e., the scheme simply takes the mean of weights across different channels. This hand-crafted naïve scheme is not only of a low efficiency, but is also vulnerable to attacks.

By contrast, we propose herein watermark embedding techniques that can be used to protect the integrity of neural networks, and the networks may be trained for many different purposes. The protection is achieved by imposing additional constraints on statistics of NN weights, such that they form certain clusters, where cluster centers can be used as basis vectors to encode secret codes. In order to protect integrity of neural networks, one can feed a set of secret codes (e.g., key(s)) to the NN in question to enable checking whether a designated output is obtained. This enables to determine if a neural network or a portion thereof is a copy of a watermarked network.

The watermark embedding methods herein are different from the method in “Embedding Watermarks into Deep Neural Networks”, in at least the following aspects, in exemplary embodiments:

1) It is the cluster centers of NN weights, rather than merely the mean of weights across different channels, that are used to encode the secret codes (e.g., key(s)). The selection of cluster centers is data-dependent (e.g., varying from datasets to datasets) and task-dependent (e.g., optimized with respect to certain inference accuracy of a specific task), thus making the selection much more robust to adversarial attacks. Techniques for determining cluster centers are described below, in section IV.

2) Optionally, the selected cluster centers may undergo another transformation, which is again controlled by private keys, making the selection more robust to malicious tampering of NN weights.

3) The cluster centers may be optimized with respect to the original neural network learning tasks.

4) Moreover, in case that the original task for the NN is image/video (or any other media content) classification, the codes (e.g., key(s)) can be embedded as secret information in the input images (or other media content), using digital steganography techniques. See, as an example of embedding such information, the following: Shumeet Baluja, “Hiding Images in Plain Sight: Deep Steganography”, NIPS, 2017; and Jamie Hayes and George Danezis, “Generating steganographic images via adversarial training”, arXiv preprint arXiv:1703.00371, 2017. Therefore, when the input images are fed to the NN in question, the integrity of the NN, such as infringement of IP rights of the owner of the NN, can be immediately identified.

### II. Training

The instant techniques may be divided into a training stage and a testing stage. The training stage is described in this section, and the testing stage is described in the next section.

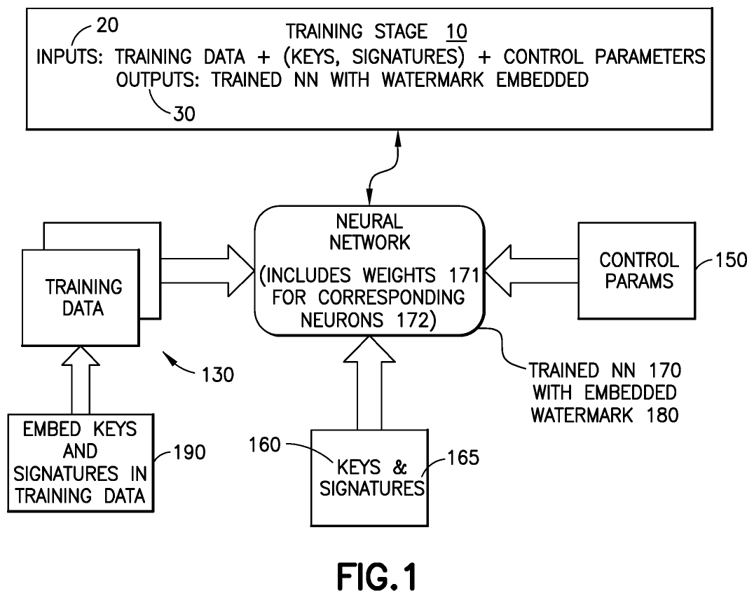

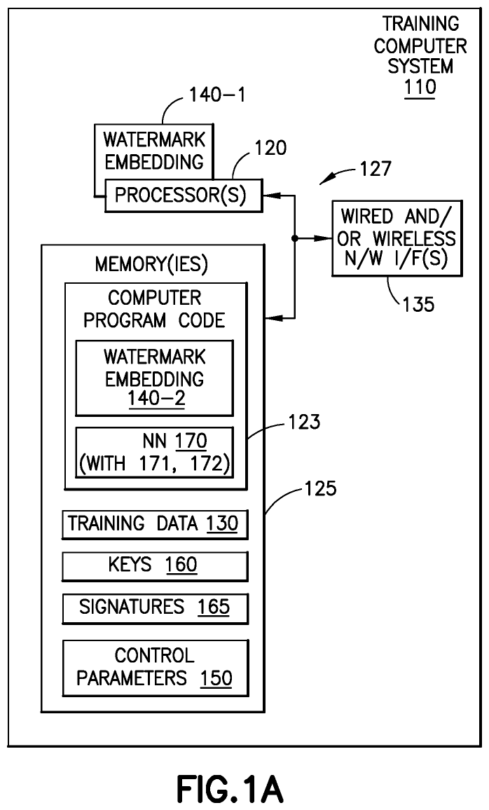

Turning to FIG. 1, this figure is a block diagram illustrating a training stage to embed keys and signatures into NN weights. The training stage 10 uses inputs 20 of training data 130, keys 160 and/or signatures 165, and control parameters (params) 150 and operates the neural network (NN) 170 using the same for training. The NN 170 includes weights 171 for corresponding neurons 172. The training stage 10 then produces outputs 30 comprising a trained NN 170 with a watermark embedded in the NN 170. That is, the NN 170 has an embedded watermark 180 after the training stage 100. One way to describe embedding the watermark is that what is embedded in the NN 170 is a capability to produce a known signature when inputting a corresponding key in the NN 170. This capability is based on constraints placed on the weights of the NN, and the constraints are based on one or more keys. Therefore, the keys and the corresponding embedding process embed a watermark into a NN.

In more detail, FIG. 1 illustrates the training stage 10, in which the network 170 in question is trained for its original task. The original task is the task for which the NN 170 is designed, such as image classification or depth estimation. The main point is that, simultaneously, a hidden task is also trained to ensure that given keys 160 fed to the NN 170 are bound to output-designated signatures 165. In other words, for testing the NN 170, there are techniques described below that should produce the signatures 165. In such a case, the network in question (that is, being tested) is deemed a copy of the original network 170, thus, potential infringement might be detected. The original network is also called an authorized network herein, as the NN could be authorized for use for by certain entities, and others that use the NN without permission would be unauthorized users.

FIG. 1 also illustrates another possibility, where in block 190 the keys 160 and corresponding signatures 165 are embedded into the training data. Testing of the NN 170 may be performed with the trained data that has the embedded keys and signatures 165. This is explained in more detail below.

Description of challenges encountered in this approach is presented after a computer system suitable for implementing the training stage 10 is described. Turning to FIG. 1A, this figure is a block diagram of computer system used for training a NN, in accordance with an exemplary embodiment. The training computer system 110 comprises one or more processors 120, one or more memories 125, and one or more wired and/or wireless network (N/W) interfaces (I/Fs) 135, interconnected though one or more buses 127. The one or more memories may comprise computer program code 123, the training data 130, the keys 160, the signatures 165, and the control parameters 150. The computer program code 123 includes the NN 170 (with the weights 171 and corresponding neurons 172), and may include a watermark embedding module 140-2. The one or more buses 127 may be address, data, or control buses, and may include any interconnection mechanism, such as a series of lines on a motherboard or integrated circuit, fiber optics or other optical communication equipment, and the like.

The training computer system 110 includes a watermark embedding module 140, comprising one of or both parts 140-1 and/or 140-2, which may be implemented in a number of ways. The watermark embedding module 140 may be implemented in hardware as watermark embedding module 140-1, such as being implemented as part of the one or more processors 120. The watermark embedding module 140-1 may be implemented also as an integrated circuit or through other hardware such as a programmable gate array. In another example, the watermark embedding module 140 may be implemented as watermark embedding module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein.

In this example, the watermark embedding module 140 is assumed to access the NN 170, but the NN 170 may also be implemented into the watermark embedding module 140. The NN 170 is also assumed to contain the weights 171.

The training computer system 110 may communicate with other computer systems via the wired and/or wireless N/W I/F(s) 135, via corresponding wired or wireless networks (not shown). The training computer system 110 may include other elements, which are not shown, such as user interface circuitry for user interface elements such as displays, mice, keyboards, touchscreens, and the like.

The computer readable memories 125 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125 may be means for performing storage functions. The processors 120 may be of any type suitable to the local technical environment, and may include one or more of general purpose computers, special purpose computers, microprocessors, digital signal processors (DSPs) and processors based on a multi-core processor architecture, as non-limiting examples. The processors 120 may be means for performing functions, such as controlling the training computer system 110, and other functions as described herein.

Now that a computer system suitable for implementing the training stage 10 has been described, details of challenges encountered in the above-described approach are now described. Regarding these challenges, the challenges are two-fold:

1) The performance of the original tasks should not be compromised, due to embedded keys 160 and signatures 165 in network weights 171. In principle, this is made possible due to the fact that NN weights 171 are invariably over-parameterized, thus, leaving sufficient spaces to encode hidden information (e.g., key and signature pairs). Technical details of exemplary embedding methods are disclosed below.

2) The encoded hidden information should be robust and error-resilient, as much as possible, with respect to possible operations applied on NN weights 171. Such operations may include legitimate processing such as fine-tuning of the NN 170, compression of the NN 170, or malicious tampering of NN weights for various purposes.

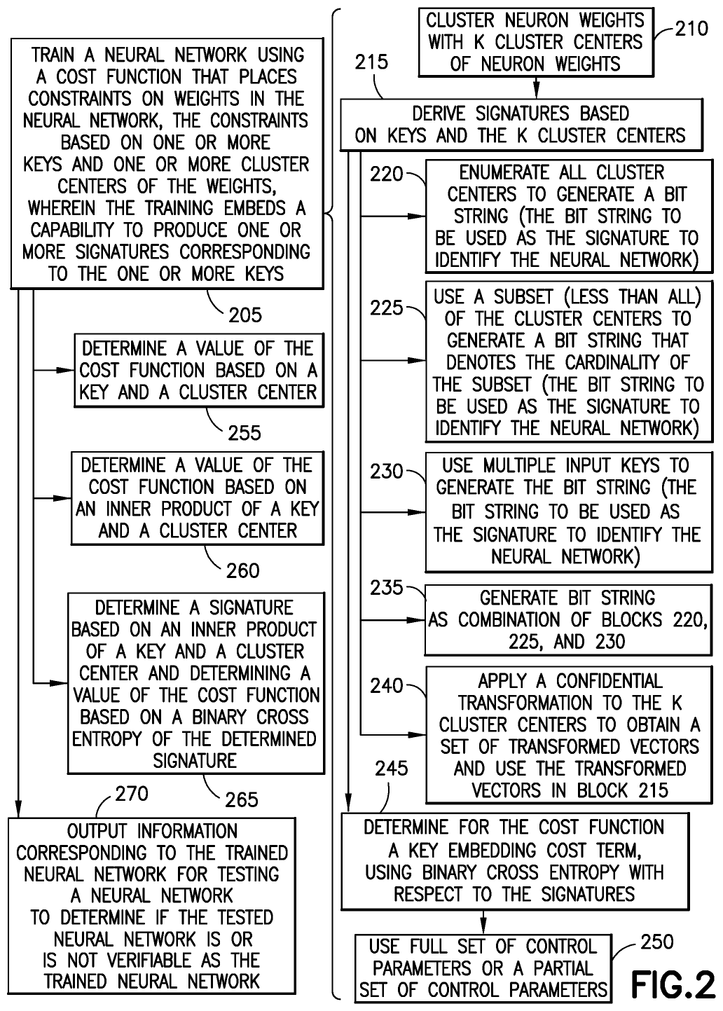

We adopt following techniques to achieve abovementioned goals. These techniques for training are presented in part using FIG. 2, which is a logic flow diagram for a training phase using watermark embedding techniques for neural networks, in accordance with exemplary embodiments. FIG. 2 illustrates the operation of an exemplary method or methods, a result of execution of computer program instructions embodied on a computer readable memory, functions performed by logic implemented in hardware, and/or interconnected means for performing functions in accordance with exemplary embodiments. The blocks in FIG. 2 are performed by the training computer system 110, e.g., under control of the watermark embedding module 140, at least in part.

In block 205, the training computer system 110 trains a neural network 170 to embed a watermark 180 into the neural network 170 using a cost function based on one or more keys and one or more cluster centers. Specifically, the training computer system 110 trains the neural network 170 using a cost function that places constraints on weights 171 in the neural network. The constraints are based on one or more keys 160 and one or more cluster centers of the weights 171. The training embeds a capability to produce one or more specific signatures 165 corresponding to the one or more keys 160.

One technique uses regularized training with keys embedded. The basic principle in the “Embedding Watermarks into Deep Neural Networks” article is to regularize NN weights with an additional cost term K_{θ}(w) integrated with the cost term for the original task, E₀(w):

E_{λ,θ}(w)=E₀(w)+λK_{θ}(w), (1)

in which λ is a parameter to control relative significance of the cost term for the original task E₀(w) and the cost term for the key embedding task K_{θ}(w), E_{λ,θ}(w) is the cost function, and θ is a parameter to control key embedding (see text below for details). As is known, a cost function is a measure of the inaccuracy of a neural network with respect to its given training sample and the expected output, and may be minimized (e.g., with a gradient descent algorithm) via adjusting neuron weights. While this basic principle in Equation (1) is also applicable to certain of the examples herein, the key embedding cost term K_{θ}(w) proposed herein in certain examples is/are fundamentally different from that of the “Embedding Watermarks into Deep Neural Networks” article. The modifications made herein aim to improve the robustness of the embedded key/signatures, thus to protect in a better way integrity (such as the IP rights of the owner) of NNs in question.

It is helpful at this point to address some terminology. The term watermark as used here refers to the modifications of NN weights caused by the second cost term in Equation (1), e.g., as modified herein by for instance by Equation (3) described below. Once this modification is embedded into the network, the NN will always map specific keys to designated signatures. Also, the watermark cannot be easily removed, without compromising the original functionality of the network. In this sense, these modifications are referred to as (e.g., a digital) watermark, and as such one analogy to the digital watermark is to the (physical) watermark on bank notes.

Note that general framework in Equation (1) is technically sound, because neural network weights are often highly over-parameterized and redundant such that the weights can encode virtually any given information, including the additional key/signature coding illustrated below.

In an exemplary embodiment, we propose to first cluster neuron weights with K cluster centers of neuron weights of the NN 170. See block 210. In block 215, the training computer system 110 derives signatures based on keys and the K cluster centers. Denote these high-dimensional cluster center vectors as Cₖ (k=1, . . . , K), then we may use the following formula to derive designated signatures sⱼ for given input key kⱼ, j=1, . . . , J, where J is the number of output bits for all input keys:

sⱼ=∈ₐ(kⱼ·Cₖ), (2)

in which

$${ϵ}_{a} ( x ) = \{ \begin{matrix}1 & x \geq a \\ 0 & otherwise\end{matrix}$$

is the step function at threshold a. By default a=0, but this threshold can be an arbitrary non-zero value, which is part of the control parameter θ (e.g., part of reference 150).

Typically, there is one-to-one correspondence between a signature sⱼ and a key kⱼ. Additionally, it is assumed in an exemplary embodiment there is a set of (key, signature) pair inputs to be fed into the system during the training, and this ensures that the input keys robustly lead to corresponding signatures.

It is remarked that by this exemplary definition sⱼ is a single bit binary value depending on the input key kⱼ and cluster center kⱼ. Note that the input key kⱼ and the cluster center Cₖ are of the same dimensionality such that the dot product between them is possible. For example, the dimensionality might 64, and higher dimensionalities are also possible, depending on the choice of different clustering parameters. Lower dimensionalities are also possible.

Another remark is that, in one embodiment (see block 220), it is possible to enumerate all cluster centers Cₖ (k=1, . . . , K) to generate a bit string sⱼₖ (k=1, . . . , K) and use the bit string as the signature to identify the neural network in question.

It is also possible to use a subset A_{L} (rather than the whole set) of cluster centers Cₖ (k∈A_{L}⊂{1, . . . , K}) to generate L bits sⱼₖ (k∈A_{L}⊂{1, . . . , K}), in which L denotes the cardinality of the subset A_{L}. See block 225. An idea here is to keep the selection of subset confidential thus protect them from malicious attacks. The indices l={, . . . ,} of cluster centers selected into the subset are part of the control parameter θ (e.g., part of reference 150).

In another embodiment, it is possible to use multiple input keys kⱼ (j=1, . . . , J) to generate the bit string sⱼₖ (j=1, . . . , J) and use the bit string as the signature. See block 230.

In yet another embodiment, the bit string sⱼₖ (k=1, . . . , K, j=1, . . . , J), combining above embodiments, can be used as the signature. That is, the bit string is generated as a combination of blocks 220, 225, and 230 in block 235.

Another remark is that, in order to improve robustness against attacks, it is possible to apply a confidential transformation ƒ on Cₖ to obtain a set of transformed vectors C′ₗ:

C′ₗ=ƒ(Cₖ),

and use the transformed vector C′ₗ in Equation (2) to compute signature bits. This transformation function ƒ is part of the control parameter θ (e.g., part of 150). See block 240.

A further remark is that the key embedding cost term, in the previous embodiments, can be defined and determined using binary cross entropy with respect to designated signatures s*ⱼₖ:

K_{θ}(w)=−Σ_{k,j=1}^{K,J}(sⱼₖ log s*ⱼₖ+(sⱼₖ)log(1−s*ⱼₖ). (3)

This is performed to determine the cost function E_{λ,θ}(w). See block 245. The cost terms in other embodiments are defined in the same vein. The cost term for the key embedding task K_{θ}(w) helps to place constraints on weights in the neural network, where the constraints are based on one or more keys and one or more cluster centers.

Another remark is that, depending on different embodiments mentioned above, the control parameters 150 include the full set θ={a, ƒ, l} or a subset of this set. See block 250. At the training stage, these control parameters 150 are used to train and embed keys into NN weights. After training, these parameters might be stored confidentially and not distributed together with the trained NN 170, since these parameters are not required for performing the original task. At the detection stage, these parameters 150 and keys 160/signatures 165 might be retrieved through separate communication channels or services, and then used to check the NN 170 in question. That is, both options are possible. The training computer system 110 (which already has the key/signature pairs) can test whether other neural networks (e.g., downloaded at the system itself or remotely accessed) are unauthorized copies of the trained network. For this, one only needs to provide the keys as input and check whether output of the tested network matched with the signatures.

Alternatively, the training computer system 110 could distribute the key/signature pairs to another computer system, which could do the testing. Again, the tested network could be located at the other computer system or could be remotely accessed (sending keys as input and receiving signatures as output). This way, the network weights as well as the embedded keys 160/signatures 165 are more error-resilient and/or more robust to malicious attacks.

In block 270, the training computer system 110 outputs information corresponding to the trained neural network 170 for testing a neural network 170-1 to determine if the tested neural network 170-1 is or is not verifiable as the trained neural network. For instance, the computer system 110 may output the trained neural network 170 and the keys 160 and signatures 165, which may then be used to determine whether a neural network is the authorized NN 170. This is described in more detail in the section below. Additionally, the keys 160 and signatures 165 may be embedded in testing data, and the testing data may be used to determine the keys 160 and signatures 165, and these may be used to determine whether a neural network is the authorized NN 170.

One example for cost function determination is described in reference to block 245. Additional examples for cost function determination are also described in blocks 255, 260, and 265. That is, other examples of cost function determination include the following:

A value for the cost function is determined based on a key and a cluster center, see block 255;

A value for the cost function is determined based on an inner product of the key (resulting in a single scalar value) and the cluster center, see block 260; and/or

A signature is determined based on the inner product of the key and the cluster center, and a value for the cost function is determined based on a binary cross entropy of the signature, see block 265, and the value is used in the training.

### III. Testing

Now that the training phase has been described, this section concerns the testing phase.

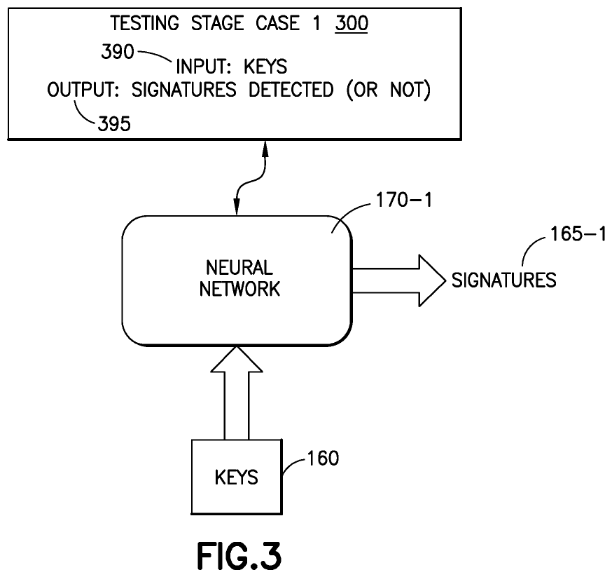

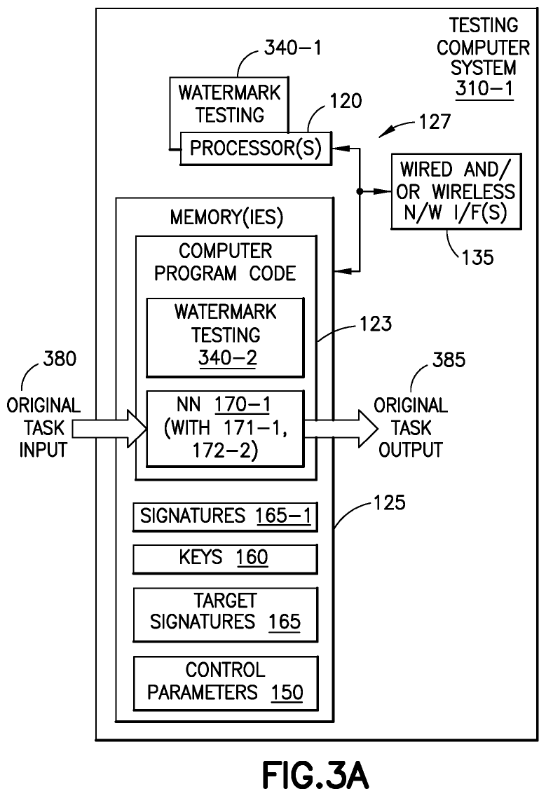

Referring to FIG. 3, this figure depicts one case (case 1 300) for this checking, which is performed during the testing stage, for which the neural network is fed with one or more keys 160 used for training as shown in FIG. 1. The testing phase is best described with an analogy. Consider (physical) watermarks on banknotes: often people pay no attention to or even are not aware of watermarks, which are only examined if there is a doubt about the banknote. In a similar vein, other computer systems can perform the original task (such as image recognition) without knowing keys/signatures. Only if there is a need to check the legal status of a NN in question, then the keys/signatures are retrieved and used to do the testing. There are many possible ways by which keys/signatures are received, e.g., we may even print them on papers and send them by post, although more likely, they are provided by trustworthy and authorized services.

The input 390 comprises the key(s) 160, and the output 395 comprises detected signature(s) 165-1 (or not, meaning that signature(s) were not detected). Then the computed (e.g., detected) signature(s) 165-1 are compared with the designated signature(s) 165 (the target), and the NN 170-1 in question is deemed to resemble the original NN 170 if the difference between the detected signature(s) 165-1 and the target signature(s) 165 is lower than certain threshold(s). Since all signature bits are binary and assumed independent, the confidence score p of detecting similar NNs 170/170-1 may be computed with the following formula:

p=1−rⁿ, (4)

in which n is the number of bits that are the same between detected signatures 165-1 and target signatures 165, and r is the probability that the bits of detected signature(s) 165-1 and target signature(s) 165 might collide accidentally. In general, the more bits that are detected as being the same, the more likely the NN 170-1 in question is a close copy of the original NN 170. In additional detail, r may be determined empirically. This probability depends on many issues: parameters λ, θ in the cost function of Equation (1) and other control parameters. One of the reasons to use these control parameters is to increase r as much as possible. Equation (4) shows that, even if r is not very high, one can still increase the overall confidence score p by using more bits (i.e., larger n). The probability p is the probability of detecting a copy of NN, e.g. 95% or 99%. However, the actual value is domain-specific, and it is unlikely to be able to specify this value beforehand.

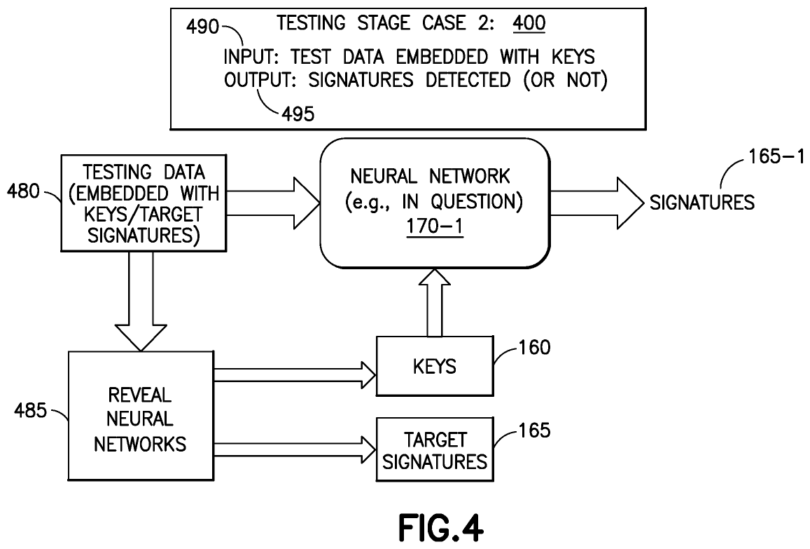

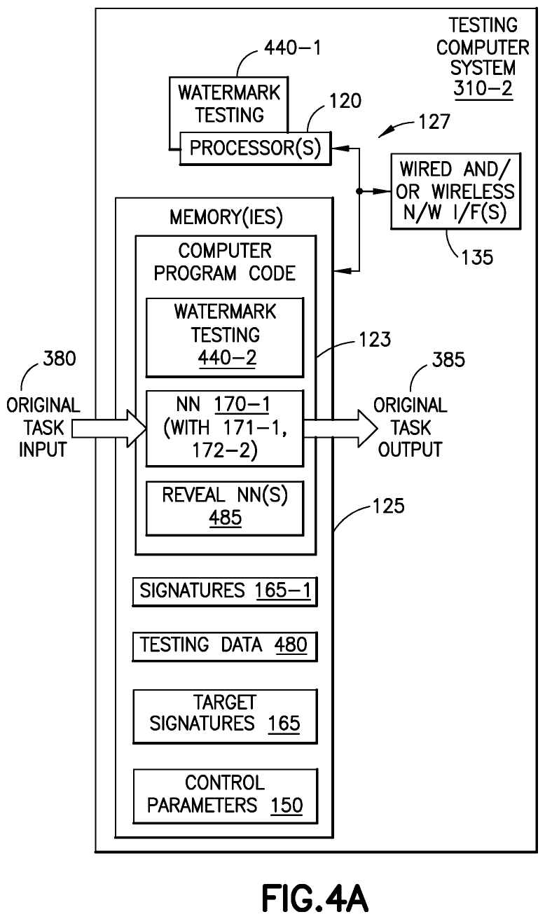

Turning to FIG. 3A, this figure is a block diagram of computer system used for testing a NN for the testing case in FIG. 3, in accordance with an exemplary embodiment. One testing computer system 310-1 is described in FIG. 3A, and another testing computer system 310-2 is described in FIG. 4A, and a testing computer system in general is referred to as testing computer system 310. Note also that the computer system 110, referred to as a training computer system, may also be a testing computer system 310 in certain exemplary embodiments. The testing computer system 310-1 is similar to the training computer system 110, so only the differences will be described herein. In this example, there is a watermark testing module 340, which may be implemented in hardware as watermark testing module 340-1, or implemented as computer program code 123 as watermark testing module 340-2, or both. The computer program code 123 is assumed to have a NN 170-1 with its own weights 171-1 and corresponding neurons 172-1, and the NN 170-1 may or may not be verified as a known NN 170.

When the other computer systems only perform the original tasks such as image recognition, these key 160/target signatures 165 are not needed. The trained networks 170-1 can be used as if there were no keys/signatures embedded. This is illustrated by the original task input 380, upon with the NN 170-1 would operate to create the output 385 (e.g., a class into which the input 380 is placed).

Only if key 160/target signature 165 pairs (for instance) are received or retrieved, e.g., through separate communication channel(s), then the testing is invoked. This is the testing use case 1 300. In this case, as also explained in reference to FIG. 3, the keys 160 are input to the NN 170-1 and signatures 165-1 are determined. If the signatures 165-1 are deemed to be similar to the target signatures 165, then the NN 170-1 is verified as the NN 170.

The use case delineated in FIG. 4 is based on the previous case, but FIG. 4 incorporates an idea of hiding keys in media content, e.g., a picture, that is to be processed by the NN 170-1 (e.g., in question) for the original task. This use case is based on a NN integrity verification/protection mechanism, which may be standardized and accepted by all legal users of NNs 170. The mechanism enforces that, if a set (e.g., one or more) of keys 160 and signatures 165 are received together, the media content (testing data 480) is to be processed. The NN 170-1 in question should pass a verification step, before the NN 170-1 can be used to perform its original task. The verification step includes retrieving/decrypting the keys 160 and target signatures 165 from the media content, and checking whether the NN in question 170-1 is a similar copy of the original neural network 170 (as disclosed in previous use case).

Thus, in testing stage case 2 400, the input 490 comprises testing data 480 that is embedded with keys 160 and corresponding target signatures 165. For example, if the key is a vector of x bits and the corresponding target signature is a single bit, the embedding could be sets of x+1 bits, each of the x+1 bits being one key and a corresponding signature. As for techniques for embedding, see, e.g., the following which describes techniques for embedding secret information in input images: Shumeet Baluja, “Hiding Images in Plain Sight: Deep Steganography”, NIPS, 2017; and Jamie Hayes and George Danezis, “Generating steganographic images via adversarial training”, arXiv preprint arXiv:1703.00371, 2017. There are one or more reveal neural network(s) 485, which reveal the keys 160 and the target signatures 165 that were previously embedded in the testing data 480. The output 495 comprises detected signature(s) (or not, meaning that signature(s) were not detected).

Turning to FIG. 4A, this figure is a block diagram of computer system used for testing a NN for the testing case in FIG. 4, in accordance with an exemplary embodiment. The testing computer system 310-2 is similar to the training computer system 310-1, so only the differences will be described herein. In this example, there is a watermark testing module 440, which may be implemented in hardware as watermark testing module 440-1, or implemented as computer program code 123 as watermark testing module 440-2, or both. As with FIG. 3A, the computer program code 123 is assumed to have a NN 170-1 with its own weights 171-1 and corresponding neurons 172-1, and the NN 170-1 may or may not be verified as a known (e.g., original) NN 170.

As with FIG. 3A, the trained networks 170-1 can be used as if there were no keys/signatures embedded. This is illustrated by the original task input 380, upon with the NN 170-1 would operate to create the output 385 (e.g., a class into which the input 380 is placed).

Only if testing data 480 and target signatures 165 are received or retrieved, e.g., through separate communication channel(s) as testing data 480, then the testing is invoked. This is the testing use case 2 400. For use (test stage) case 2, the key/signature pairs are hidden in the media content (shown as testing data 480) to be processed for the original task (e.g. images to be recognized). In this case, steganography techniques might be used to hide the key/signatures. See, e.g., the following: Shumeet Baluja, “Hiding Images in Plain Sight: Deep Steganography”, NIPS, 2017; and Jamie Hayes and George Danezis, “Generating steganographic images via adversarial training”, arXiv preprint arXiv:1703.00371, 2017. In this case, as also explained in reference to FIG. 4, the testing data 480 is embedded with the keys 160 and the target signatures 165, and the reveal NN(s) 485 are operated on the testing data 480 to determine the keys 160 and the target signatures 165. The keys 160 are then input to the NN 170-1 and signatures 165-1 are determined. If the signatures 165-1 are deemed to be similar to the target signatures 165, then the NN 170-1 is verified as the NN 170.

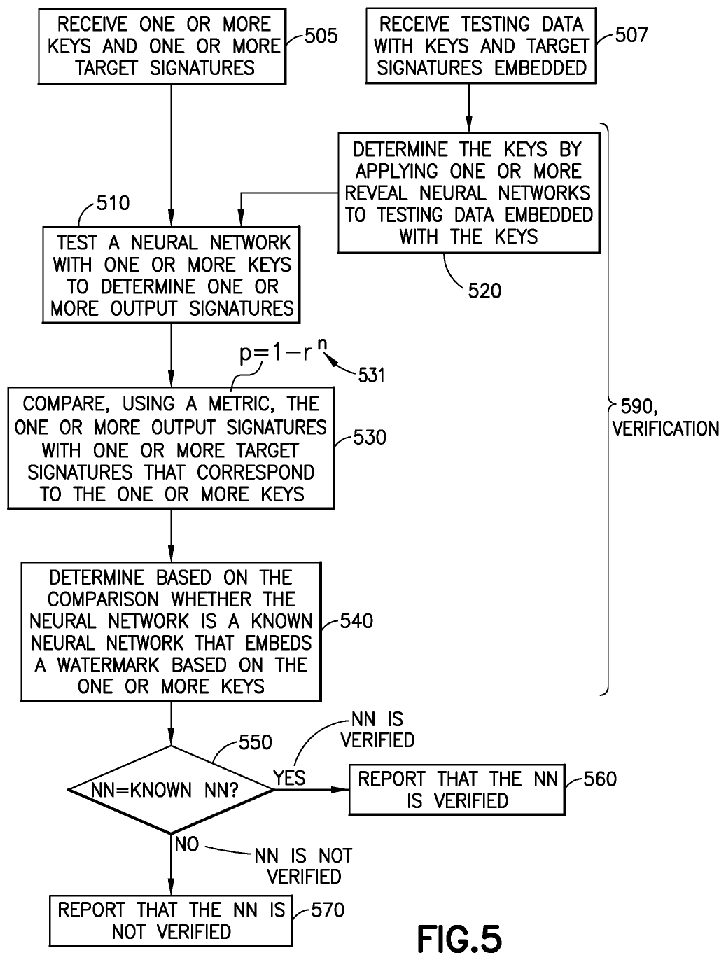

Turning to FIG. 5, this figure is a logic flow diagram for a testing phase using watermark embedding techniques for neural networks, in accordance with exemplary embodiments. FIG. 5 also illustrates the operation of an exemplary method or methods, a result of execution of computer program instructions embodied on a computer readable memory, functions performed by logic implemented in hardware, and/or interconnected means for performing functions in accordance with exemplary embodiments. The blocks in FIG. 5 are performed by the testing computer system 310, e.g., under control of the watermark embedding module 340 or 440, at least in part. FIG. 5 includes a representation of the operations in FIGS. 3 and 4, and includes additional operations too.

As described above, there is a verification step that is performed on a neural network 170-1 in question, to determine whether the neural network 170-1 is an original neural network 170, which has been embedded with the watermark 180 (as defined by the keys 160 and corresponding signatures 165). This verification step is illustrated in FIG. 5 as verification 590 and comprises multiple operations, in this example, blocks 510, 520, 530, and 540.

The verification 590 of the NN 170-1 may be triggered in a number of ways. In this example, in block 505, the testing computer system 310 receives one or more keys 160 and one or more target signatures 165, and this acts as a trigger to trigger block 510. In block 507, the testing computer system 310 receives testing data 480 with embedded keys 160 and target signatures 165. This acts as a trigger to trigger block 520. Explicit triggers, e.g., via signaling or other means, may also be used. The testing computer system 310 may also retrieve (and therefore receive) the information via one or more communication channels.

In block 510, the testing computer system 310 tests a neural network 170-1 with one or more keys 160 to determine one or more output signatures 165-1. The method may also include in block 520 determining the keys 160 by applying one or more reveal neural networks 485 to testing data 480 embedded with the keys 160. Block 520 has also been described in more detail in reference to FIG. 4. The keys 160 and the target signatures 165 are determined in block 520 in order to perform the testing in block 510.

In block 530, the testing computer system 310 performs the operation of comparing, using a metric, the one or more output signatures 165-1 with one or more target signatures 165 that correspond to the one or more keys 160. One example of a metric 531 is the metric of p=1−rⁿ, described above in reference to Equation (4), although other metrics might be used. The testing computer system 310 in block 540 determines based on the comparison whether the neural network 170-1 is a known neural network 170 that embeds a watermark 180 based on the one or more keys 160 (e.g., and corresponding signatures 160).

At the conclusion of block 540, the NN 170-1 is or is not verified. This is illustrated by block 550, where it is tested whether the NN 170-1 is a known (e.g., original) neural network 170. If so (block 550=Yes, meaning the NN 170-1 is verified), in block 560 the testing computer system 310 reports that the NN is verified. It is noted that this might be the case when the original network is fine-tuned, so that the signatures can still be determined with high probability, e.g., 95% but not necessarily 100%. If not (block 550=No, meaning that the NN 170-1 is not verified), the testing system 310 reports that the NN is not verified in block 570. The reporting may be performed via any technique, such as sending a message, outputting a message to a screen, and the like.

### IV. Determining Cluster Centers

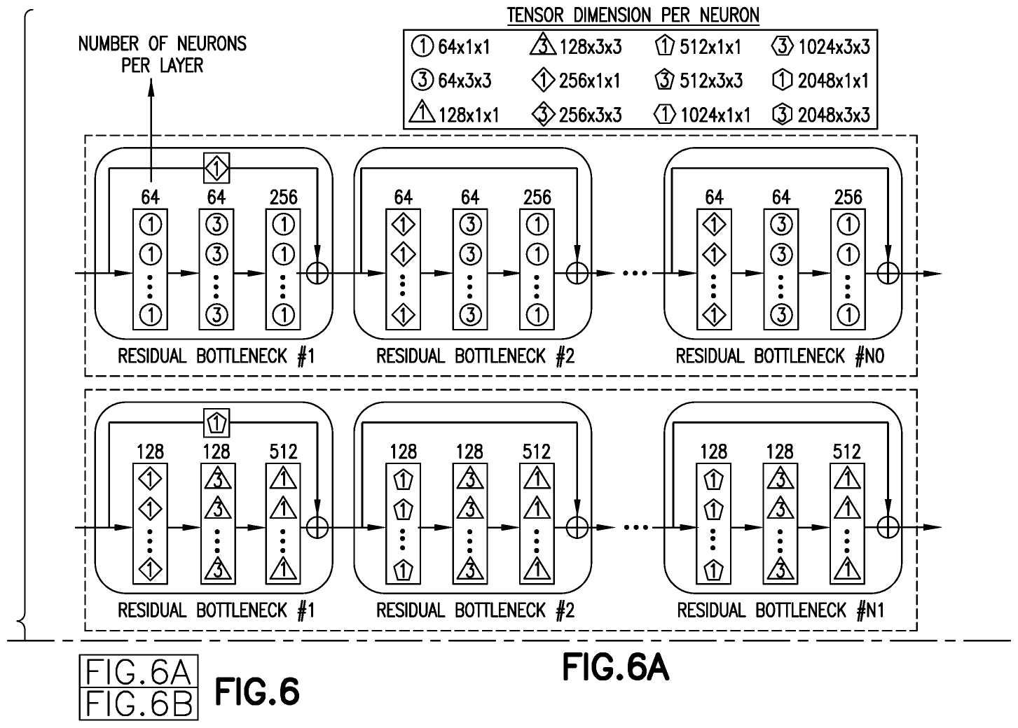

This section concerns examples of determining cluster centers. This part of the descriptions uses an the example of a ResNet, as described in the following: K. He, X. Zhang, S. Ren, and J. Sun, “Deep Residual Learning for Image Recognition”, arXiv:1512.03385v1 [cs.CV] 10 Dec. 2015 (also published as part of the proceedings of Computer Vision and Pattern Recognition (CVPR), pp. 770-778). The ResNet-based network architecture is illustrated in FIG. 6.

IV.1 Neural Network Representation

As illustrated in FIG. 6, which is spread over FIGS. 6A and 6B, a typical ResNet comprises four groups of high-level sections based on the number of intermediate feature maps (256, 512, 1024 and 2048). Each section comprises multiple (N0, N1, N2 and N3 for four sections respectively) residual bottlenecks which further comprise three convolutional layers and one residual connection. Each convolutional layer comprises a number of neurons or filters with a prescribed (totally 12) tensor dimensions listed in FIG. 6. Two exemplary NN representation schemes are introduced below and are described in the following subsections.

IV.1.1 Scheme 1

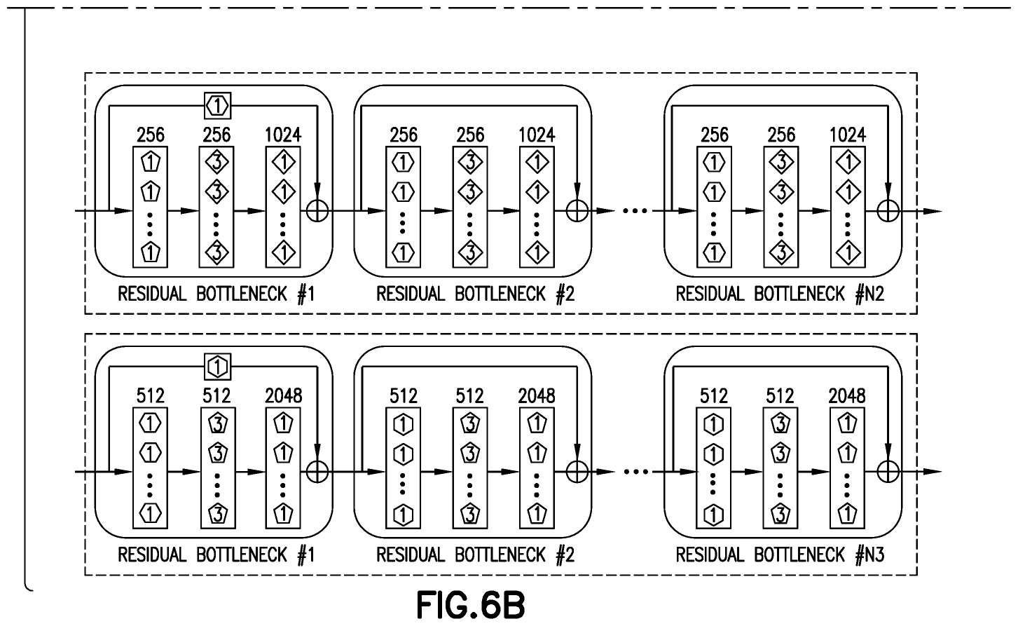

The weights of each neuron are in the dimension of one of 12 tensors sized as shown in FIG. 6, i.e., 64×1×1, 64×3×3, 128×1×1, 128×3×3, 256×1×1, 256×3×3, 512×1×1, 512×3×3, 1024×1×1, 1024×3×3, 2048×1×1, and 2048×3×3. All weights/tensors are divided into multiple instances with respect to the minimum neuron tensor dimension (64×1×1) across 3D space, i.e., splitting all neuron tensors firstly along the first dimension and then the second and third dimensions to produce 18 64×1×1 tensors as illustrated in FIG. 7. There are two groups of tensors, each with nice 64-bit tensors. This splitting process would also be performed for the rest of the tensors that are not the 64×1×1 tensors.

A clustering algorithm (e.g., k-means) is performed on the set of 64×1×1 tensors to form N clusters. The number of N clusters may be found through many different techniques. One such technique may be that the number of clusters can be specified by a human based on expert domain knowledge. As another technique, N can be determined by running a grid search in a range of prescribed codebook lengths which is detailed in Equation (5):

N=arg [symbol] (1−P(W_{N})+α log₂ N), (5)

where P(W_{N}) denotes an inference precision of the neural network reconstructed based on a codebook W_{N} which is generated by setting a number of clusters as N, the second term log₂ N calculates a bit rate used to transform a longest coded neuron tensor, α denotes a parameter to balance the accuracy and efficiency of the codebook, arg min (or argmin) stands for argument of the minimum and is a known function, and [symbol] is a set of all positive integers.

If a codebook scheme is used, the codebook can be used to represent the neural network. For instance, it is possible to have a neural network representation method as follows: generate codebooks for trained models of neural networks; assign a codeword from the codebook for each neuron of the network; transmit the codebook and codeword of neurons with the associated codebook rather than actual weights; retransmit to warrant the reception of codebook and codeword. Retransmission of missing codewords is cheap and efficient due to the much smaller amount of information. Furthermore, there may also be a neural network reconstruction method as follows: an end-user receives the codeword and reconstructs the neural network through a codebook look-up table; the end-user may i) directly use reconstructed network for inference or ii) retrain/fine-tune the neural network model given a need of accuracy or purpose.

Concerning this clustering, deep neural networks have a large amount of redundant neuron weights 171, largely due to the fact that the network architectures are manually designed based on the empirical hypothesis that deeper networks tend to have better capability to fit a variety of mappings. Another observation is that neurons 172 residing in similar layers or blocks tend to extract similar feature representations, e.g., certain layers extract corner-like feature while others might extract edges. Neurons 172 at similar levels in the hierarchy naturally lie in close vicinity to each other in the weight space. Two observations of network redundancy and methods that exploit the redundancy can be found in following articles: Chih-Ting Liu, et al., “Computation-Performance Optimization of Convolutional Neural Networks with Redundant Kernel Removal”, arXiv:1705.10748v3 [cs.CV] 10 Apr. 2018; and Yu Cheng, et al., “An Exploration of Parameter Redundancy in Deep Networks with Circulant Projections”, arXiv:1502.03436v2 [cs.CV] 27 Oct. 2015.

Other clustering methods can also be utilized such as Affinity Propagation, Spectral Clustering, and Mean-shift. Each method favors different kinds of data distributions. K-means is a more general-purposed method which has been used as the default method for many clustering problems. That being said, one can treat the selection of clustering algorithm also as part of hyper-parameter selection (similar to the selection of N) and use, e.g., a grid search to find an optimal method. The optimal selection may be the one which produces the minimum value of Equation (5) among all the candidate clustering methods.

The cluster center is normally the mean value of each cluster such as in K-means. The cluster center can also be one of the ‘central’ data such as in the Mean-shift clustering method.

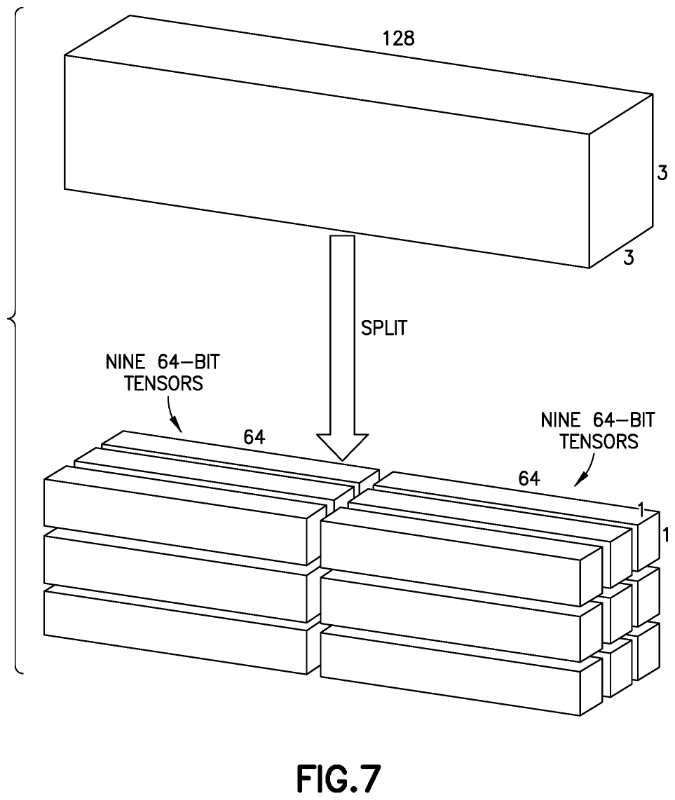

As illustrated in FIG. 8, examples of the resulting clusters and corresponding cluster centers are shown. This example illustrates a 64 dimensional (D) tensor space, since this is the minimum neuron tensor dimension (64×1×1) of the 12 sizes illustrated in FIG. 6. The clusters are clusters 810-1, 810-2, and 810-3. Each of the corresponding and respective cluster centers 820-1, 820-2, and 820-3 is illustrated with an “x”. It is noted that the resulted cluster centers 820 may form a codebook (e.g., a key-value dictionary such as an N×64 matrix in this example) and each tensor may be assigned with a cluster ID (1-N). Each neuron which was split into one or multiple 64×1×1 tensors may be encoded by their associated cluster IDs, e.g., one 64×3×3 neuron might be encoded as [1,1,4,5,5,5,1,1,2] or binary codes whose lengths depend on the number of clusters.

IV.1.2 Scheme 2

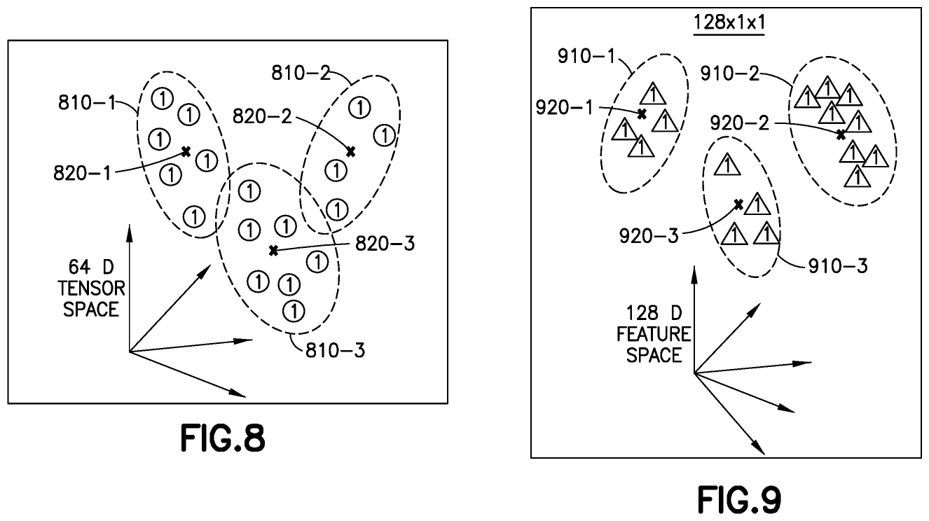

As opposed to clustering the split tensors of all neurons, a second approach is to generate a cluster for each size of tensor. FIG. 6 illustrates 12 different sizes of tensors: 64×1×1, 64×3×3, 128×1×1, 128×3×3, 256×1×1, 256×3×3, 512×1×1, 512×3×3, 1024×1×1, 1024×3×3, 2048×1×1, and 2048×3×3. For each type of tensor, the number of clusters can be determined by running a grid search based on Equation (5). The example of FIG. 9 illustrates clustering that is performed on all 128×1×1 tensors, thus the 128 D feature space is used. The clusters 910-1, 910-2, 910-3 have corresponding cluster centers 920-1, 920-2, and 920-3. There would be 11 other feature spaces for the 11 other sizes of tensors.

For a codebook example, FIG. 6 helps to illustrate that, as opposed to clustering the split tensors of all neurons, another approach is to generate a sub-codebook for each size of tensor, and the sub-codebooks may be merged to form a final codebook to represent the neural network. In terms of representing the neural network, a difference from Scheme 1 in selecting the number of clusters is that the neural network is reconstructed in such a way that only the neurons of the current tensor size are restored using the codebook while the other neurons of the network remain the original weights. Clustering is performed for each size of tensor and sub-codebooks are generated. The final codebook may generated by merging all the sub-codebooks with cluster ids with respect to the total length of codebook.

### V. Additional Examples

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIGS. 1A, 3A, and 4A. A computer-readable medium may comprise a computer-readable storage medium (e.g., memories 125 or other device) that may be any media or means that can contain, store, and/or transport the instructions for use by or in connection with an instruction execution system, apparatus, or device, such as a computer. A computer-readable storage medium does not comprise propagating signals.

If desired, the different functions discussed herein may be performed in a different order and/or concurrently with each other. Furthermore, if desired, one or more of the above-described functions may be optional or may be combined.

Although various aspects are set out above, other aspects comprise other combinations of features from the described embodiments, and not solely the combinations described above.

It is also noted herein that while the above describes example embodiments of the invention, these descriptions should not be viewed in a limiting sense. Rather, there are several variations and modifications which may be made without departing from the scope of the present invention.

1. A method, comprising:
training a neural network using a cost function that places constraints on weights in the neural network, the constraints based on one or more keys and one or more cluster centers of the weights, wherein the training embeds a capability to produce one or more signatures corresponding to the one or more, keys; and
outputting information corresponding to the trained neural network for testing a neural network to determine if the tested neural network is or is not verifiable as the trained neural network.

2. The method according to claim 1, wherein training comprises determining a value of the cost function based on a key and a cluster center and using the value of the cost function in the training.

3. (canceled)

4. (canceled)

5. The method according to claim 1, wherein training comprises:
clustering weights with K cluster centers of the weights;
deriving the one or more signatures based on the one or more keys and the K cluster centers; and
determining for the cost function a key embedding cost term, using binary cross entropy with respect to the one or more signatures.

6.-11. (canceled)

12. A method, comprising:
testing a neural network with one or more keys to determine one or more output signatures, wherein the neural network has an embedded capability to produce one or more signatures corresponding to the one or more keys, and the capability is based on constraints placed on weights in the neural network during training, the constraints based on one or more keys and one or more cluster centers of the weights, the one or more cluster centers based on weights used in the neural network;
comparing, using a metric, the one or more output signatures with one or more other signatures that correspond to the one or more keys;
determining based on the comparison whether the neural network is or is not verified as a known neural network with the embedded capability to produce specific signatures corresponding to the one or more keys; and
in response to the neural network determined to be verified as the known neural network, reporting the neural network as being verified.

13. The method according to claim 12, wherein comparing, using a metric, the one or more output signatures with one or more other signatures that correspond to the one or more keys further comprises:
determining a confidence score p based on the following:
p=1−rⁿ,
in which n is a number of bits that are a same between the one or more output signatures and the one or more other signatures, and r is a probability that the bits of the one or more output signatures and the one or more target signatures might collide accidentally.

14.-34. (canceled)

35. An apparatus, comprising:
at least one processor; and
at least one memory including computer program code,
the at least one memory and the computer program code configured, with the at least one processor, to cause the apparatus at least to:
train a neural network using a cost function that places constraints on weights in the neural network, the constraints based on one or more keys and one or more cluster centers of the weights, wherein the training embeds a capability to produce one or more signatures corresponding to the one or more keys; and
output information corresponding to the trained neural network for testing a neural network to determine if the tested neural network is or is not verifiable as the trained neural network.

36. The apparatus according claim 35, wherein the training comprises determining a value of the cost function based on a key and a cluster center and using the value of the cost function in the training.

37. The apparatus according to claim 35, wherein the training comprises determining a value of the cost function based on an inner product of a key and a cluster center and using the value of the cost function in the training.

38. The apparatus according to claim 35, wherein the training comprises determining a signature based on an inner product of a key and a cluster center and determining a value of the cost function based on a binary cross entropy of the determined signature.

39. The apparatus according to claim 35, wherein the training comprises:
clustering weights with K cluster centers of the weights;
deriving the one or more signatures based on the one or more keys and the K cluster centers; and
determining for the cost function a key embedding cost term, using binary cross entropy with respect to the one or more signatures.

40. The apparatus according to claim 39, wherein the deriving the one or more signatures further comprises enumerating all cluster centers to generate a bit string, wherein the bit string is used as a set of a plurality of multiple signatures that identifies the trained neural network.

41. The apparatus according to claim 39, wherein the deriving the one or more signatures further comprises using a subset of cluster centers to generate a bit string that denotes a cardinality of the subset, and the bit string is a set of a plurality of signatures that identifies the trained neural network.

42. The apparatus according to claim 39, wherein the deriving the one or more signatures further comprises using multiple input keys to generate a bit string, and the bit string is a set of a plurality of signatures that identifies the trained neural network.

43. The apparatus according to claim 42, wherein the deriving the one or more signatures further comprises generating the bit string as a combination of any two of the following: enumerating all cluster centers to generate the bit string; using a subset of cluster centers to generate the bit string; or using multiple input keys to generate the bit string.

44. The apparatus according to claim 39, wherein deriving the one or more signatures further comprises applying a confidential transformation to the K cluster centers to obtain a set of transformed vectors and using the transformed vectors when deriving the one or more signatures.

45. The apparatus according to claim 35, wherein the training is performed based on multiple control parameters, and wherein the training is performed using one of a complete set of the multiple control parameters or a partial set of the multiple control parameters.

46. An apparatus, comprising:
at least one processor; and
at least one memory including computer program code,
the at least one memory and the computer program code configured, with the at least one processor, to cause the apparatus at least to:
test a neural network with one or more keys to determine one or more output signatures, wherein the neural network has an embedded capability to produce one or more signatures corresponding to the one or more keys, and the capability is based on constraints placed on weights in the neural network during training, the constraints based on one or more keys and one or more cluster centers of the weights, the one or more cluster centers based on weights used in the neural network;
compare, using a metric, the one or more output signatures with one or more other signatures that correspond to the one or more keys;
determine based on the comparison whether the neural network is or is not verified as a known neural network with the embedded capability to produce specific signatures corresponding to the one or more keys; and
in response to the neural network determined to be verified as the known neural network, report the neural network as being verified.

47. The apparatus of claim 46, wherein comparing, using a metric, the one or more output signatures with one or more other signatures that correspond to the one or more keys further comprises:
determining a confidence score p based on the following:
p=1−rⁿ,
in which n is a number of bits that are a same between the one or more output signatures and the one or more other signatures, and r is a probability that the bits of the one or more output signatures and the one or more target signatures might collide accidentally.

48. The apparatus according to claim 46, wherein the at least one memory and the computer program code are configured, with the at least one processor, to cause the apparatus at least to:
determine, prior to the testing, the one or more keys and the one or more target signatures by applying one or more reveal neural networks to testing data embedded with the one or more keys and the one or more target signatures.

49. The apparatus according to claim 46, wherein the at least one memory and the computer program code are configured, with the at least one processor, to cause the apparatus at least to: receive the one or more keys and the one or more target signatures prior to the testing.

50. (canceled)

51. (canceled)
